(19) United States
(12) Patent Application Publication
(10) Pub. No.: US 2024/0026095 A1
(43) Pub. Date: Jan. 25, 2024

(54) METHOD OF PREPARING A COMPOUND HAVING ELASTOMER AND FILLER

(71) Applicant: Beyond Lotus LLC, Wilmington, DE (US)

(72) Inventor: Michael D. Morris, Nashua, NH (US)

(21) Appl. No.: 18/256,270

(22) PCT Filed: Dec. 8, 2021
(86) PCT No.: PCT/US2021/062429

§ 371 Date: Jun. 7, 2023

Related U.S. Application Data
(60) Provisional application No. 63/123,399, filed on Dec. 9, 2020.

(51) Int. Cl. C08J 3/22; C08J 3/215

(52) U.S. Cl. CPC C08J 3/226; C08J 3/215; C08J 2307/02; C08J 2407/02; C08J 2309/06; C08J 2409/06

(57) ABSTRACT

Disclosed herein are methods of preparing a composite. In one aspect, the method comprises: (a) charging a mixer having one or more rotors with: (i) at least a liquid masterbatch comprising a first filler dispersed in at least one elastomer, and (ii) a wet filler comprising a second filler and a liquid; (b) in one or more mixing steps, mixing the at least the liquid masterbatch and the wet filler to form a mixture; and (c) discharging, from the mixer, the composite comprising the first and second fillers dispersed in the at least one elastomer at a total loading of at least 20 phr, wherein the composite has a liquid content of no more than 10% by weight based on total weight of said composite.

### FIELD OF THE INVENTION

Disclosed herein are methods of making composites and resulting vulcanizates from liquid masterbatches and wet filler.

### BACKGROUND

There is always a desire in the rubber industry to develop methods to disperse filler in elastomer and it is especially desirable to develop methods which can do so efficiently with respect to filler dispersion quality, time, effort, and/or cost.

Numerous products of commercial significance are formed of elastomeric compositions wherein reinforcing filler is dispersed in any of various synthetic elastomers, natural rubber or elastomer blends. Carbon black and silica, for example, are widely used to reinforce natural rubber and other elastomers. It is common to produce a masterbatch, that is, a premixture of reinforcing filler, elastomer, and various optional additives, such as extender oil. Such masterbatches are then compounded with processing and curing additives and upon curing, generate numerous products of commercial significance. Such products include, for example, pneumatic and non-pneumatic or solid tires for vehicles, including the tread portion including cap and base, undertread, innerliner, sidewall, wire skim, carcass and others. Other products include, for example, engine mounts, bushings, conveyor belts, windshield wipers, rubber components for aerospace and marine equipment, vehicle track elements, seals, liners, gaskets, wheels, bumpers, anti-vibration systems and the like.

A good dispersion of reinforcing filler in rubber compounds has been recognized as a factor in achieving mechanical strength and consistent elastomer composite and rubber compound performance. Considerable effort has been devoted to the development of methods to improve dispersion quality, and various solutions have been offered to address this challenge. For example, more intensive mixing can improve reinforcing filler dispersion, but can degrade the elastomer into which the filler is being dispersed. This is especially problematic in the case of natural rubber, which is highly susceptible to mechanical/thermal degradation, especially under dry mixing conditions.

Accordingly, there is a need to develop methods to incorporate a variety of fillers into solid elastomers to achieve acceptable and/or enhanced elastomer composite dispersion quality and functionality from elastomer composite masterbatches, which can translate into acceptable or enhanced properties in the corresponding vulcanized rubber compounds and rubber articles.

### SUMMARY

Disclosed herein are methods of preparing a composite. In one aspect, the method comprises:
(a) charging a mixer having one or more rotors with: (i) at least a liquid masterbatch comprising a first filler dispersed in at least one elastomer, and (ii) a wet filler comprising a second filler and a liquid present in an amount ranging from 15% to 65% by weight based on total weight of wet filler;
(b) in one or more mixing steps, mixing the at least the liquid masterbatch and the wet filler to form a mixture, wherein in at least one of said mixing steps conducting said mixing at mixer temperatures controlled by at least one temperature-control means, and removing at least a portion of the liquid from the mixture by evaporation; and
(c) discharging, from the mixer, the composite comprising the first and second fillers dispersed in the at least one elastomer at a total loading of at least 20 phr, wherein the composite has a liquid content of no more than 10% by weight based on total weight of said composite.

With regard to any aspect or method or embodiment disclosed herein, where applicable, the method can further comprise any one or more of the following embodiments: wherein in step (b) and optionally in step (a), the at least one temperature-control means is set to a temperature Tz of 65° C. or higher, e.g., a TCU temperature ranging from 65° C. to 100° C.; one or more rubber chemicals are absent from the composite discharged in step (c); the wet filler has a liquid present in an amount of ranging from 30% to 65% by weight.

With regard to any aspect or method or embodiment disclosed herein, where applicable, the method can further comprise any one or more of the following embodiments: the at least one elastomer is selected from natural rubber, functionalized natural rubber, styrene-butadiene rubber, functionalized styrene-butadiene rubber, polybutadiene rubber, functionalized polybutadiene rubber, polyisoprene rubber, ethylene-propylene rubber, isobutylene-based elastomers, polychloroprene rubber, nitrile rubber, hydrogenated nitrile rubber, polysulfide rubber, polyacrylate elastomers, fluoroelastomers, perfluoroelastomers, silicone elastomers, and blends thereof; the charging further comprises charging the mixer with at least one additional elastomer; the at least one additional elastomer is different from the at least one elastomer of the liquid masterbatch to form a composite comprising an elastomer blend; the at least one elastomer of the liquid masterbatch is natural rubber and the at least one additional elastomer is selected from polybutadiene and styrene-butadiene rubber.

With regard to any aspect or method or embodiment disclosed herein, where applicable, the method can further comprise any one or more of the following embodiments: the filler comprises at least one material selected from carbonaceous materials, carbon black, silica, nanocellulose, lignin, clays, nanoclays, metal oxides, metal carbonates, pyrolysis carbon, reclaimed carbon, graphenes, graphene oxides, reduced graphene oxide, carbon nanotubes, combinations thereof, and coated and treated materials thereof; the filler comprises at least one material selected from carbon black, silica, and silicon-treated carbon black; the filler comprises carbon black; the wet filler comprises never-dried carbon black; the wet filler comprises dry carbon black that has been rewetted; the filler comprises silica; the wet filler comprises never-dried silica; where the filler comprises silica, the method further comprising charging the mixer with a coupling agent.

### DETAILED DESCRIPTION

Disclosed herein are methods of preparing or forming a composite by mixing a liquid masterbatch with a wet filler.

When mixing fillers and elastomers, the challenge is to ensure the mixing time is long enough to ensure sufficient filler dispersion before the elastomer in the mixture experiences high temperatures and undergoes degradation. In the methods disclosed herein, utilizing a wet filler (e.g., comprising a filler and a liquid) allows the batch time and temperature to be controlled beyond that attainable with known dry mixing processes, and may provide other benefits such as enhancing filler dispersion and/or facilitating rubber-filler interactions and/or improving rubber compound performance. It can be effective when sufficient liquid is used to wet a substantial portion or substantially all of the filler surfaces prior to mixing with liquid masterbatch. In general, and as described here, the mixing process can be managed by controlling one or more mixer or process parameters, such as mixer surface temperatures and/or rotor speeds, fill factor, the incorporation of rubber chemicals (if any) at later times of the mixing cycle, composite discharge temperatures, and/or the application of two or more mixing stages.

The composite formed by the methods disclosed herein can be considered an uncured mixture of filler(s) and elastomer(s), optionally with one or more additives, in which the additives are discussed in further detail herein. The composite formed can be considered a mixture or masterbatch. The composite formed can be, as an option, an intermediate product that can be used in subsequent rubber compounding and one or more vulcanization processes. The composite, prior to the compounding and vulcanization, can also be subjected to additional processes, such as one or more holding steps or further mixing step(s), one or more additional drying steps, one or more extruding steps, one or more calendering steps, one or more milling steps, one or more granulating steps, one or more baling steps, one or more twin-screw discharge extruding steps, or one or more rubber working steps to obtain a rubber compound or a rubber article.

The methods for preparing a composite include the step of charging or introducing into a mixer at least a liquid masterbatch and a wet filler, e.g., a) one or more liquid masterbatches and b) one or more fillers wherein at least one filler or a portion of at least one filler has been wetted with a liquid prior to mixing with the liquid masterbatch. The combining of the liquid masterbatch with wet filler forms a mixture during the mixing step(s). The method further includes, in one or more mixing steps, conducting said mixing wherein at least a portion of the liquid is removed by evaporation or an evaporation process that occurs during the mixing. The liquid of the wet filler is capable of being removed by evaporation (and at least a portion is capable of being removed under the claimed mixing conditions) and can be a volatile liquid, e.g., volatile at bulk mixture temperatures. For example, the liquid can have a boiling point at 1 atm. of 180° C. or less, e.g., 170° C. or less, 160° C. or less, 150° C. or less, 140° C. or less, 130° C. or less, 120° C. or less, 110° C. or less, or 105° C. or less, such as having a boiling point of from 60° C. to 180° C., from 60° C. to 170° C., from 60° C. to 160° C., from 60° C. to 150° C., from 60° C. to 140° C., from 60° C. to 130° C., from 60° C. to 120° C., from 60° C. to 110° C., from 60° C. to 100° C., from 60° C. to 90° C., from 90° C. to 180° C., from 90° C. to 170° C., from 90° C. to 160° C., from 90° C. to 150° C., from 90° C. to 140° C., from 90° C. to 130° C., from 90° C. to 120° C., from 90° C. to 110° C., from 90° C. to 100° C., from 95° C. to 120° C., or from 95° C. to 110° C. For example, a volatile liquid can be distinguished from oils (e.g., extender oils, process oils) which can be present during at least a portion of the mixing as such oils are meant to be present in the composite that is discharged and thus, do not evaporate during a substantial portion of the mixing time.

“Liquid masterbatch” as used herein refers to a masterbatch derived from elastomer latex or polymer solution and a filler slurry (e.g., carbon black or silica slurry) that is fed to a liquid mixing system, e.g., an agitated tank. Such “liquid masterbatch” techniques can be used with natural rubber latex and emulsified synthetic elastomers, such as styrene butadiene rubber (SBR), or other elastomeric polymers in liquid form. Continuous or semi-continuous techniques for producing liquid masterbatch, such as those disclosed in U.S. Pat. Nos. 6,048,923 and 8,586,651, the contents of which are incorporated by reference herein, have been effective for producing liquid masterbatch composites characterized by high quality.

With regard to the liquid masterbatch that is used in the any of the methods disclosed herein, the masterbatch is in a solid form during charging and subsequent mixing with the wet filler. The liquid masterbatch can include a dewatered and/or dried product of a liquid masterbatch process. Accordingly, the liquid masterbatch comprises at least one elastomer and at least one filler. The liquid masterbatch for purposes of the present invention has a water content (or moisture content) of 5% or less, 4% or less, 3% or less, 2% or less, 1% or less, or from 0.1% to 5%, 0.5% to 5%, 1% to 5%, 0.5% to 4%, by weight, and the like.

The liquid masterbatch (e.g., the starting masterbatch) comprises an elastomer that includes at least one filler and, optionally, other components. For instance, the liquid masterbatch can comprise, on a dry weight basis, 10 phr to 100 phr filler pre-dispersed in the elastomer, or from 20 phr to 100 phr, from 20 phr to 80 phr, from 30 phr to 70 phr, or from 40 phr to 60 phr pre-dispersed filler in the elastomer, and the like. Other components can be present in amounts from 0.1 phr to less than 50 phr.

The liquid masterbatch can contain any elastomer, any filler, any additive and any combination thereof, in any amounts, as described and exemplified herein and as known in the art. The total filler contained in the final composite includes predispersed filler in the liquid masterbatch in addition to the wet filler added according to the methods disclosed herein.

The liquid masterbatch may be a composite, mixture or compound made by a liquid masterbatch process and may be any other pre-blended composite of filler dispersed in a elastomer while the elastomer is in a liquid state, e.g., a latex, suspension or solution, or in a wet state, e.g., an intermediate material from synthetic or natural rubber manufacturing processes. The liquid masterbatch may be obtained by any liquid-liquid masterbatch process, or any other liquid or wet masterbatch process, for example, the processes described in U.S. Pat. No. 6,048,923, 6,929,783B2, 8,586,651B2, 10,000,612B2, 10,000,613B2, 10,301,439B2, 10,125,229B2, 9,758,627B2, 10,179,843B2, 10,343,455, 10,106,674, 10,017,612, 10,253,141, 9,834,658, 9,616,712, US2019/002650A1, US2019/031836A1, WO2018/219631A1, and PCT/US20/36168, each of which is hereby incorporated by reference.

The liquid masterbatch can be or include natural and/or synthetic elastomers and/or rubbers. Elastomer types include natural rubbers (NR), styrene butadiene rubbers (SBR, such as solution SBR (SSBR), emulsion SBR (ESBR), or oil-extended SSBR (OESSBR)), polybutadiene (BR) and polyisoprene rubbers (IR), ethylene-propylene rubber (e.g., EPDM), isobutylene-based elastomers (e.g., butyl rubber), polychloroprene rubber (CR), nitrile rubbers (NBR), hydrogenated nitrile rubbers (HNBR), polysulfide rubbers, polyacrylate elastomers, fluoroelastomers, perfluoroelastomers, and silicone elastomers.

Exemplary elastomers include natural rubber, SBR, BR, IR, functionalized SBR, functionalized BR, functionalized NR, EPDM, butyl rubber, halogenated butyl rubber, CR, NBR, HNBR, fluoroelastomers, perfluoroelastomers, and silicone rubber, e.g., natural rubber, functionalized natural rubber, styrene-butadiene rubber, functionalized styrene-butadiene rubber, polybutadiene rubber, functionalized polybutadiene rubber, polyisoprene rubber, ethylene-propylene rubber, nitrile rubber, hydrogenated nitrile rubber, hydrogenated SBR, and blends thereof, or e.g., natural rubber, styrene-butadiene rubber, polybutadiene rubber, and blends thereof. Blends of two or more types of elastomers can be formed including blends of synthetic and natural rubbers or with two or more types of synthetic or natural rubber. Other synthetic polymers that can be used in the present methods (whether alone or as blends) include hydrogenated SBR, and thermoplastic block copolymers (e.g., such as those that are recyclable). Synthetic polymers include copolymers of ethylene, propylene, styrene, butadiene and isoprene. Other synthetic elastomers include those synthesized with metallocene chemistry in which the metal is selected from Ce, Pr, Nd, Sm, Gd, Tb, Dy, Ho, Tm, Yb, Lu, Co, Ni, and Ti. Polymers made from bio-based monomers can also be used, such as monomers containing modern carbon as defined by ASTM D6866, e.g., polymers made from bio-based styrene monomers disclosed in U.S. Pat. No. 9,868,853, the disclosure of which is incorporated by reference herein, or polymers made from bio-based monomers such as butadiene, isoprene, ethylene, propylene, farnesene, and comonomers thereof. For example, blends can be formed by combining one or more elastomers (“additional” or “second” elastomer(s), and the like) with at least one liquid masterbatch and the resulting blend subsequently charged to the mixer with the wet filler. Alternatively, the additional elastomer can be charged to the mixer with the liquid masterbatch and wet filler followed by mixing. As an option, additional elastomers can be charged to the mixer separately or as an elastomer pre-blend.

Alternatively and/or in addition, the composite discharged after mixing the liquid masterbatch with the wet filler (and optionally additional elastomers) can be further blended with one or more elastomers or additional masterbatches. The additional masterbatch can be: a liquid masterbatch; a masterbatch formed by mixing a solid elastomer with a filler (wet or dry filler such as silica, carbon black, silicon-treated carbon black, and/or any filler disclosed herein); a masterbatch in a wet state, e.g., an intermediate material from synthetic or natural rubber manufacturing processes or composite manufacturing processes, having a water (or moisture or aqueous fluid content) of 25%, by weight or less, based on the total weight of the liquid masterbatch in wet state; or a combination thereof.

For example, the additional masterbatch can be a liquid masterbatch formed from solvent masterbatch processes. For example, silica/elastomer masterbatches can be prepared as described in U.S. Pat. Nos. 9,758,627 and 10,125,229, or masterbatches from neodymium-catalyzed polybutadienes as described in U.S. Pat. No. 9,758,646, the disclosures of which are incorporated by reference herein. The masterbatch can have a fibrous filler, such as poly(p-phenylene terephthalamide) pulp, as described in U.S. Pat. No. 6,068,922, the disclosure of which is incorporated by reference herein. Other masterbatches include those described in PCT Publ. No. WO 2020/247663, the disclosures of which are incorporated by reference herein. For example, the masterbatch can have a filler such as carbon black and/or silica and an elastomer such as SBR and/or butadiene rubber. The additional masterbatch can be a commercially available masterbatch such as Emulsil™ silica/SBR masterbatch or Emulblack™ carbon black/SBR masterbatch (both available from Dynasol group). Additional elastomers or additional masterbatches can comprise the same elastomer as the liquid masterbatch, or at least one different elastomer, selected from one or more of the elastomers described herein or known in the art, and can further comprise at least one rubber chemical as described herein or known in the art.

Exemplary masterbatches comprising elastomer blends include: blends of natural rubber with synthetic, bio-sourced, and/or functionalized elastomers (e.g., SSBR, ESBR, BR) where the filler can be selected from one or more of carbon black, silica, and silicon-treated carbon black.

The liquid masterbatch can be or include natural rubber. The natural rubber may also be chemically modified in some manner. For example, it may be treated to chemically or enzymatically modify or reduce various non-rubber components, or the rubber molecules themselves may be modified with various monomers or other chemical groups such as chlorine. Other examples include epoxidized natural rubber and natural rubber having a nitrogen content of at most 0.3 wt. %, as described in PCT Publ. No. WO 2017/207912.

Other exemplary elastomers include, but are not limited to, rubbers, polymers (e.g., homopolymers, copolymers and/or terpolymers) of 1,3-butadiene, styrene, isoprene, isobutylene, 2,3-dialkyl-1,3-butadiene, where alkyl may be methyl, ethyl, propyl, etc., acrylonitrile, ethylene, propylene and the like. The elastomer may have a glass transition temperature (Tg), as measured by differential scanning calorimetry (DSC), ranging from −120° C. to 0° C. Examples include, but are not limited to, styrene-butadiene rubber (SBR), natural rubber and its derivatives such as chlorinated rubber, polybutadiene, polyisoprene, poly(styrene-co-butadiene) and the oil extended derivatives of any of them. Blends of any of the foregoing may also be used. Particular suitable synthetic rubbers include: copolymers of styrene and butadiene comprising from about 10 percent by weight to about 70 percent by weight of styrene and from about 90 to about 30 percent by weight of butadiene such as a copolymer of 19 parts styrene and 81 parts butadiene, a copolymer of 30 parts styrene and 70 parts butadiene, a copolymer of 43 parts styrene and 57 parts butadiene and a copolymer of 50 parts styrene and 50 parts butadiene; polymers and copolymers of conjugated dienes such as polybutadiene, polyisoprene, polychloroprene, and the like, and copolymers of such conjugated dienes with an ethylenic group-containing monomer copolymerizable therewith such as styrene, methyl styrene, chlorostyrene, acrylonitrile, 2-vinyl-pyridine, 5-methyl-2-vinylpyridine, 5-ethyl-2-vinylpyridine, 2-methyl-5-vinylpyridine, allyl-substituted acrylates, vinyl ketone, methyl isopropenyl ketone, methyl vinyl either, alpha-methylene carboxylic acids and the esters and amides thereof, such as acrylic acid and dialkylacrylic acid amide. Also suitable for use herein are copolymers of ethylene and other high alpha olefins such as propylene, 1-butene, and 1-pentene. Other polymers are disclosed in U.S. Publ. No. 2018/0282523 and European Patent 2423253B1, the disclosures of which are incorporated herein by reference. Other polymers include silicone-based elastomers or hybrid systems that have silicones and hydrocarbon domains.

The liquid masterbatch can be one piece or multiple pieces or a bulk particulate material. Multiple pieces of the liquid masterbatch or bulk particulate material can be attained by cutting or grinding the liquid masterbatch using methods well known in the art. The size of these pieces can have dimensions of at least 1 μm e.g., at least 10 Linn or at least 100 μm up to 10 cm, up to 5 cm, or up to 1 cm.

The at least the liquid masterbatch and wet filler are charged (e.g. fed, introduced) into the mixer. The charging can occur in any fashion including, but not limited to, conveying, metering, dumping and/or feeding in a batch, semi-continuous, or continuous flow of the liquid masterbatch and the wet filler into the mixer.

As an option of the charging step, the liquid masterbatch can be masticated until it reaches a predetermined temperature, e.g., a temperature of about 90° C. or 100° C. or higher prior to charging the wet filler into the mixer. Alternatively, the liquid masterbatch can be masticated with at least a portion of the wet filler to a temperature of about 90° C. or 100° C. or higher prior to the start of any actual mixing. This temperature can be from 90° C. to 180° C., from 100° C. to 180° C., from 110° C. to 170° C., from 120° C. to 160° C., or from 130° C. to 160° C. The elastomer can be masticated using an internal mixer such as a Banbury mixer, an extruder, a roll mill, a continuous compounder, or other rubber mixing equipment.

As an option, the charging of wet filler can be such that dry filler is introduced into the mixer and wetted by adding the liquid (either sequentially or simultaneously or near simultaneously) to form the wet filler in the mixer, and then the liquid masterbatch can be added to the mixer. The introduction of dry filler to be wetted can be performed with all of the filler intended to be used or a portion thereof (e.g., wherein one or more additional portions of the wet filler are further added to the mixer to obtain the intended total amount of starting wet filler).

As an option, the liquid masterbatch (all or part) or wet filler (all or part) can be added to the mixer separately but within 20 minutes of each other or within 15 minutes or within 10 minutes or within 5 minutes, or within 1 minute, within 30 seconds of each other, or within 15 seconds of each other.

With regard to mixing, the mixing can be performed in one or more mixing steps. By “one or more mixing steps,” it is understood that one mixing step is performed or a first mixing step is followed by further mixing steps prior to discharging. For example, the one or more mixing steps can comprise a first mixing step in which the liquid masterbatch and wet filler are mixed under conditions in which minimal amounts of liquid are removed by evaporation. For example, the first mixing step can form a pre-blend. The mixture from this first mixing step can then be subjected to a second or further mixing step. As understood in the art, a mixing step is equivalent to a mixing stage.

As indicated, during the one or more mixing steps, in any of the methods of the present invention, at least some liquid present in the mixture and/or wet filler introduced is removed at least in part by evaporation. As an option, the majority (by wt %) of any liquid removed from the mixture occurs by evaporation. For example, at least 50% of liquid is removed by evaporation, based on total weight of liquid removed during the mixing. The total weight of liquid removed can be determined from the difference between liquid content of the wet filler and any liquid remaining in the composite when discharged from the mixer plus any liquid present in the mixer that can be drained as a liquid when the composite is discharged from the mixer. For example, when the composite is discharged, additional liquid may also be discharged, whether with the composite or through other outlets provided in the mixer. Other examples include liquid removal by evaporation of at least 50%, at least 60%, at least 70%, at least 80%, or from 51% to 100%, from 51% to 95%, from 51% to 90%, from 51% to 80%, from 51% to 70%, from 60% to 100%, from 60% to 95%, from 60% to 90%, or from 60% to 80% by weight of the total liquid contained in the wet filler that is charged to the mixer.

As an option, the one or more mixing steps or stages can further remove a portion of the liquid from the mixture by expression, compaction, and/or wringing, or any combinations thereof. Alternatively, a portion of the liquid can be drained from the mixer after or while the composite is discharged.

With regard to the mixer that can be used in the method of the present invention, any suitable mixer can be utilized that is capable of combining (e.g., mixing together or compounding together) a filler with liquid masterbatch. The mixer(s) can be a batch mixer or a semi-continuous or a continuous mixer. A combination of mixers and processes can be utilized in the present invention, and the mixers can be used in tandem sequence and/or integrated with other processing equipment. The mixer can be an internal or closed mixer or an open mixer, or an extruder or a continuous compounder or a kneading mixer or a combination thereof. The mixer can be capable of incorporating filler into liquid masterbatch and/or capable of dispersing the filler in the elastomer and/or distributing the filler in the elastomer. Any one or combination of commercial mixers to produce rubber compounds can be used in the present methods.

The mixer can have one or more rotors (at least one rotor). The at least one rotor or the one or more rotors can be screw-type rotors, intermeshing rotors, tangential rotors, kneading rotor(s), rotors used for extruders, a roll mill that imparts significant total specific energy, or a creper mill. Generally, one or more rotors are utilized in the mixer, for example, the mixer can incorporate one rotor (e.g., a screw type rotor), two, four, six, eight, or more rotors. Sets of rotors can be positioned in parallel and/or in sequential orientation within a given mixer configuration.

The one or more mixing steps can be a single mixing step, e.g., a one-stage or single stage mixing step or process. At least one of the mixer temperatures are controlled by temperature controlled means. In addition, one or more rotors of at least one of the mixers operate at tips speed of at least 0.6 m/s for at least 50% of mixing time and/or the temperature-control means can be set to a temperature (TCU temperature) of 65° C. or higher. The one or more mixing steps can be batch or continuous mixing. In certain instances, in a single stage or single mixing step the composite can be discharged with a liquid content of no more than 10% by weight. In other embodiments, two or more mixing steps or mixing stages can be performed so long as one of the mixing steps is performed under one or more of the stated conditions.

The temperature-control means can be, but is not limited to, the flow or circulation of a heat transfer fluid through channels in one or more parts of the mixer. For example, the heat transfer fluid can be water or heat transfer oil. For example, the heat transfer fluid can flow through the rotors, the mixing chamber walls, the ram, and the drop door. In other embodiments, the heat transfer fluid can flow in a jacket (e.g., a jacket having fluid flow means) or coils around one or more parts of the mixer. As another option, the temperature control means (e.g., supplying heat) can be electrical elements embedded in the mixer. The system to provide temperature-control means can further include means to measure either the temperature of the heat transfer fluid or the temperature of one or more parts of the mixer. The temperature measurements can be fed to systems used to control the heating and cooling of the heat transfer fluid. For example, the desired temperature of at least one surface of the mixer can be controlled by setting the temperature of the heat transfer fluid located within channels adjacent one or more parts of the mixer, e.g., walls, doors, rotors, etc.

The temperature of the at least one temperature-control means can be set and maintained, as an example, by one or more temperature control units (“TCU”). This set temperature, or TCU temperature, is also referred to herein as “T_{z}.” In the case of temperature-control means incorporating heat transfer fluids, T_{z} is an indication of the temperature of the fluid itself.

As an option, the temperature-control means can be set to a temperature, T_{z}, ranging from 30° C. to 150° C., from 40° C. to 150° C., from 50° C. to 150° C., or from 60° C. to 150° C., e.g., from 30° C. to 155° C., from 30° C. to 125° C., from 40° C. to 125° C., from 50° C. to 125° C., from 60° C. to 125° C., from 30° C. to 110° C., from 40° C. to 110° C., from 50° C. to 110° C., 60° C. to 110° C., from 30° C. to 100° C., from 40° C. to 100° C., from 50° C. to 100° C., 60° C. to 100° C., from 30° C. to 95° C., from 40° C. to 95° C., from 50° C. to 95° C., 50° C. to 95° C., from 30° C. to 90° C., from 40° C. to 90° C., from 50° C. to 90° C., from 65° C. to 95° C., from 60° C. to 90° C., from 70° C. to 110° C., from 70° C. to 100° C., from 70° C. to 95° C., 70° C. to 90° C., from 75° C. to 110° C., from 75° C. to 100° C., from 75° C. to 95° C., or from 75° C. to 90° C. Other ranges are possible with equipment available in the art.

Compared to dry mixing, under similar situations of filler type, elastomer type, and mixer type, the present processes can allow higher energy input. Controlled removal of the water from the mixture enables longer mixing times and consequently improves the dispersion of the filler. As described herein, the present process provides operating conditions that balance longer mixing times with evaporation or removal of water in a reasonable amount of time.

Other operating parameters to be considered include the maximum pressure that can be used. Pressure affects the temperature of the filler and rubber mixture. If the mixer is a batch mixer with a ram, the pressure inside the mixer chamber can be influenced by controlling the pressure applied to the ram cylinder.

As disclosed herein, the liquid masterbatch comprises at least one elastomer in which is dispersed a filler. The filler dispersed in the masterbatch can be the same or different from the filler of the wet filler; accordingly, the liquid masterbatch can comprise a first filler and the wet filler can comprise a second filler. The first and second fillers, independently, can comprise a single filler or a blend of fillers. For example, the first filler can be a filler blend whereas the second filler can be a single filler type, the first filler can be a single filler type and the second filler be a filler blend, or the first and second fillers can each be a single filler type or each be a filler blend.

In any methods disclosed herein, the discharging step from the mixer occurs and results in a composite comprising the filler dispersed in the natural rubber at a total loading of at least 20 phr, e.g., from 20 to 250 phr, or other loading disclosed herein, i.e., a total of the at least first and second fillers. As an option, discharging occurs on the basis of a defined mixing time. The mixing time between the start of the mixing and discharging can be about 1 minute or more, such as from about 1 minute to 40 minutes, from about 1 minute to 30 minutes, from about 1 minute to 20 minutes, or from 1 minute to 15 minutes, or from 3 minutes to 30 minutes, from 5 minutes to 30 minutes, or from 5 minutes to 20 minutes, or from 5 minutes to 15 minutes, or from 1 minute to 12 minutes, or from 1 minute to 10 minutes or other times. Alternatively, for batch internal mixers, ram down time can be used as a parameter to monitor batch mixing times, e.g., the time that the mixer is operated with the ram in its lowermost position e.g., fully seated position or with ram deflection as described herein. Ram down time can be less than 30 min., less than 15 min., less than 10 min., or ranges from 3 min. to 30 min or from 5 min. to 15 min, or from 5 min. to 10 min. As an option, discharging occurs on the basis of dump or discharge temperature. For example, the mixer can have a dump temperature ranging from 120′C to 190° C., 130° C. to 180° C., such as from 140° C. to 180° C., from 150° C. to 180° C., from 130° C. to 170° C., from 140° C. to 170° C., from 150° C. to 170° C., or other temperatures within or outside of these ranges.

The methods further include discharging from the mixer the composite that is formed. The discharged composite can have a water content of no more than 10% by weight based on the total weight of the composite, as outlined in the following equation:

Water content of composite %=100*[mass of water]/[mass of water+mass of dry composite]

In any of the methods disclosed herein, the discharged composite can have a water content of no more than 10% by weight, no more than 5% (e.g., where the filler also comprises water), no more than 2%, or no more than 1%, based on the total weight of the composite. This amount can range from 0.1% to 10%, from 0.1% to 5%, from 0.1% to 3%, from 0.1% to 2%, from 0.5% to 5%, or from 0.5% to 5%, based on the total weight of the composite discharged from the mixer at the end of the process.

In any of the methods disclosed herein, water content (moisture content) in the composite can be the measured as weight % of water present in the composite based on the total weight of the composite. Any number of instruments are known in the art for measuring water content in rubber materials, such as a coulometric Karl Fischer titration system, or a moisture balance, e.g., from Mettler (Toledo International, Inc., Columbus, OH).

In any of the methods disclosed herein, while the discharged composite can have a water content of 10% by weight or less, there optionally may be water present in the mixer which is not held in the composite that is discharged. This excess water is not part of the composite and is not part of any water content calculated for the composite.

In any of the methods disclosed herein, the total water content of the material charged into the mixer is higher than the water content of the composite discharged at the end of the process. For instance, the water content of the composite discharged can be lower than the liquid content of the material charged into the mixer by an amount of from 10% to 99.9% (wt % vs wt %), from 10% to 95%, or from 10% to 50%.

In some dry mixing processes, one or more rubber chemicals (e.g., processing aids) can be charged early in the mix cycle to aid incorporation of the filler. However, the rubber chemicals can interfere with binding or interaction between filler and elastomer surfaces and have a negative impact on vulcanizate properties. It has been discovered that the use of a wet filler enables mixing in the absence of, or substantial absence of, such rubber chemicals.

Accordingly, as an option any method disclosed herein can comprise charging a mixer with at least the liquid masterbatch and wet filler and, in one or more mixing steps, mixing the liquid masterbatch and the wet filler to form a mixture in the substantial absence of rubber chemicals at mixer temperatures controlled by at least one temperature-control means. Optionally the process further comprises adding at least one additive selected from anti-degradants and coupling agents during the charging or the mixing, i.e., during the one or more mixing steps. Examples of such anti-degradants (e.g. anti-oxidants) and coupling agents are described herein. As defined herein, “substantial absence” refers to a process wherein the charging step and the one or more mixing steps can be carried out in the presence of the one or more rubber chemicals in an amount less than 10% by weight of the total amount of rubber chemicals ultimately provided in a vulcanizate prepared from the composite, e.g., the cured composite, or the charging step and the one or more mixing steps can be carried out in the presence of the one or more rubber chemicals in an amount less than 5% or less than 1% by weight of the total amount of rubber chemicals ultimately in the composite. As it is optional to include the rubber chemicals in the composite, a suitable measure of determining “substantial absence” of the one or more rubber chemicals is to determine the amount targeted in the vulcanizate prepared from the composite, e.g., after curing the composite. Thus, a nominal amount of the one or more rubber chemicals may be added during said charging or mixing but not an amount sufficient to interfere with filler-elastomer interaction. As a further example of “substantial absence,” the charging and mixing can be carried out in the presence of the one or more rubber chemicals in an amount or loading of 5 phr or less, 4 phr or less, 3 phr or less, 2 phr or less, 1 phr or less, or 0.5 phr or less, 0.2 phr or less, 0.1 phr or less, based on the resulting vulcanizate.

In any embodiment disclosed herein, as an option, after the mixing of at least the liquid masterbatch and wet filler has commenced and prior to the discharging step, the method can further include adding at least one anti-degradant to the mixer so that the at least one anti-degradant is mixed in with the liquid masterbatch and wet filler. The optional adding of the anti-degradant(s) can occur at any time prior to the discharging step. For instance, the adding of the anti-degradant(s) can occur prior to the composite being formed and having a water content of 10 wt % or less, or 5 wt % or less. Examples of an anti-degradant that can be introduced is N-(1,3-dimethylbutyl)-N′-phenyl-p-phenylenediamine (6PPD), and others are described in other sections herein. The anti-degradant can be introduced in an amount ranging from 1% to 5%, from 0.5% to 2%, or from 0% to 3% based on the weight of the composite that is formed. Anti-degradants added during the charging step or the mixing step may help prevent elastomer degradation during the mixing; however, due to the presence of the water in the mixture, the rate of degradation of the elastomer is lower compared to dry mix processes and the addition of anti-degradant can be delayed.

After the composite is formed and discharged, the method can include the further optional step of mixing the composite with additional elastomer to form a composite comprising a blend of elastomers. The “additional elastomer” or second elastomer can be additional natural rubber or can be an elastomer that is not natural rubber such as any one or more synthetic elastomers disclosed herein (e.g. styrene butadiene rubbers (SBR), polybutadiene (BR) and polyisoprene rubbers (IR), ethylene-propylene rubber (e.g., EPDM), isobutylene-based elastomers (e.g., butyl rubber), polychloroprene rubber (CR), nitrile rubbers (NBR), hydrogenated nitrile rubbers (HNBR), polysulfide rubbers, polyacrylate elastomers, fluoroelastomers, perfluoroelastomers, and silicone elastomers). Blends of two or more types of elastomers (blends of first and second elastomers), including blends of synthetic and natural rubbers or with two or more types of synthetic or natural rubber, may be used as well.

In addition to the liquid masterbatch and wet filler, the mixer can be charged with one or more charges of at least one additional elastomer to form a composite blend. As another option, the process can comprise mixing the discharged composite with additional elastomer to form the blend. The at least one additional elastomer can be the same as the solid elastomer or different from the solid elastomer.

Alternatively, the composite when discharged may contain at least one additive selected from antidegradants and coupling agents, which can be added at any time during the charging or mixing.

Alternatively, the one or more rubber chemicals can be added at a mixer temperature of 120° C. or higher; at this point the filler has been distributed and incorporated into the elastomer, and the addition of rubber chemicals is not expected to interfere with the interaction between filler and elastomer.

In any of the methods disclosed herein, the discharging step from the mixer occurs and results in a composite comprising the filler (total of first and second fillers) dispersed in the elastomer at a loading of at least 20 phr. For instance, the filler loading can range from 20 phr to 250 phr, from 20 phr to 200 phr, from 20 phr to 180 phr, from 20 phr to 150 phr, from 20 phr to 100 phr, from 20 phr to 90 phr, from 20 phr to 80 phr, 30 phr to 200 phr, from 30 phr to 180 phr, from 30 phr to 150 phr, from 30 phr to 100 phr, from 30 phr to 80 phr, from 30 phr to 70 phr, 40 phr to 200 phr, from 40 phr to 180 phr, from 40 phr to 150 phr, from 40 phr to 100 phr, from 40 phr to 80 phr, from 35 phr to 65 phr, or from to 55 phr. As an option, other filler loadings are applicable and disclosed herein. Fillers include carbon black, silica, silicon-treated carbon black, and other fillers disclosed herein, and blends thereof.

In certain embodiments at least 50% of the filler (e.g., at least 75% or at least 90% of the filler) is selected from carbon black, and coated and treated materials thereof. In certain embodiments at least 50% of the filler (e.g., at least 75% or at least 90% of the filler) is silica. In certain embodiments at least 50% of the filler (e.g., at least 75% or at least 90% of the filler) is silicon-treated carbon black.

The wet filler that is used in any of the methods disclosed herein can be a solid material, e.g., a solid bulk material, in the form of a powder, paste, pellet or cake. In the methods, the wet filler can be dispersed in the elastomer at a loading ranging from 1 phr to 100 phr on a dry weight basis, or a loading ranging from 20 phr to 250 phr, from 20 phr to 200 phr, e.g., from 20 phr to 180 phr, from 20 phr to 150 phr, from 20 phr to 120 phr, or from 20 phr to 100 phr, as well as other ranges disclosed herein.

In any of the methods disclosed herein, a wet filler, such as a wet carbon black, wet silica, or wet silicon-treated carbon black can have a liquid content (e.g., water content) of 80% by weight or less, such as 70% or less, 60% or less, 50% or less, 40% or less, 30% or less, such as from about 15% to about 80%, by weight, from about 20% to about 80%, from about 25% to about 80%, from about 30% to about 80%, from about 35% to about 80%, from about 40% to about 80%, from about 15 wt. % to about 70%, from about 20 wt. % to about 70%, from about 25% to 70%, from about 30% to 70%, from about 35% to about 80%, from about 40% to 70%, from about 15 wt. % to about 65%, from about 20% to about 65%, from about 25% to about 65%, from about 30 wt. % to about 65%, from about 35% to about 65%, from about 40% to about 65%, from about 15% to about 60%, from about 20% to about 60%, from about 25% to about 60%, from about 30% to about 60%, from about 35% to about 60%, or from about 40% to 60% by weight relative to the total weight of the filler, or any other ranges from these various values given herein. The wet filler can have a liquid content in an amount of at least 30% by weight (based on the weight of the filler), or at least 40% by weight, or from 20% to 80% by weight.

As disclosed herein, the first and second filler can be independently selected to be the same or different. The filler, whether it be the first and/or second filler, can be chemically treated (e.g. chemically treated carbon black, chemically treated silica, silicon-treated carbon black) and/or chemically modified. The filler can be or include carbon black having an attached organic group(s). The filler can have one or more coatings present on the filler (e.g. silicon-coated materials, silica-coated material, carbon-coated material). The filler can be oxidized and/or have other surface treatments.

The first and second fillers can be independently selected from particulate or fibrous or plate-like fillers. For example, a particulate filler is made of discrete bodies. Such fillers can often have an aspect ratio (e.g., length to diameter) of 3:1 or less, or 2:1 or less, or 1.5:1 or less. Fibrous fillers can have an aspect ratio of, e.g., 2:1 or more, 3:1 or more, 4:1 or more, or higher. Typically, fillers used for reinforcing elastomers have dimensions that are microscopic (e.g., hundreds of microns or less) or nanoscale (e.g., less than 1 micron). In the case of carbon black, the discrete bodies of particulate carbon black refer to the aggregates or agglomerates formed from primary particles, and not to the primary particles themselves. In other embodiments, the filler can have a platelike structure such as graphenes and reduced graphene oxides.

The first and second fillers can independently comprise at least one material that is selected from carbonaceous materials, carbon black, silica, nanocellulose, lignin, clays, nanoclays, metal oxides, metal carbonates, pyrolysis carbon, reclaimed carbon, recovered carbon black (e.g., as defined in ASTM D8178-19, rCB, graphenes, graphene oxides, reduced graphene oxide (e.g., reduced graphene oxide worms as disclosed in PCT Publ. No. WO 2019/070514A1, or densified reduced graphene oxide granules as disclosed in U.S. Prov. Appl. No. 62/857,296, filed Jun. 5, 2019, and PCT Publ. No. 2020/247681, the disclosures of which are incorporated herein by reference), carbon nanotubes, single-wall carbon nanotubes, multi-wall carbon nanotubes, combinations thereof, and coated and treated materials thereof. Other suitable fillers include carbon nanostructures (CNSs, singular CNS), a plurality of carbon nanotubes (CNTs) that are crosslinked in a polymeric structure by being branched, e.g., in a dendrimeric fashion, interdigitated, entangled and/or sharing common walls with one another. CNS fillers are described in U.S. Pat. No. 9,447,259, and PCT Appl. No. PCT/US2021/027814, the disclosures of which are incorporated by reference herein. The filler can be chemically treated (e.g. chemically treated carbon black, chemically treated silica, silicon-treated carbon black) and/or chemically modified. The filler can be or include carbon black having an attached organic group(s). The filler can have one or more coatings present on the filler (e.g. silicon-coated materials, silica-coated material, carbon-coated material). The filler can be oxidized and/or have other surface treatments. There is no limitation with respect to the type of filler (e.g., silica, carbon black, or other filler) that can be used.

As mentioned previously, fibrous fillers can also be incorporated in the methods disclosed herein as the first and/or second filler, including natural fibers, semi-synthetic fibers, and/or synthetic fibers (e.g., nanosized carbon filaments), such as short fibers disclosed in PCT Publ. No. WO 2021/153643, the disclosure of which is incorporated by reference herein. Other fibrous fillers include poly(p-phenylene terephthalamide) pulp, commercially available as Kevlar® pulp (Du Pont).

Other suitable fillers include bio-sourced or bio-based materials (derived from biological sources), recycled materials, or other fillers considered to be renewable or sustainable include hydrothermal carbon (HTC, where the filler comprises lignin that has been treated by hydrothermal carbonization as described in U.S. Pat. Nos. 10,035,957, and 10,428,218, the disclosures of which are incorporated by reference, herein), rice husk silica, carbon from methane pyrolysis, engineered polysaccharide particles, starch, siliceous earth, crumb rubber, and functionalized crumb rubber. Exemplary engineered polysaccharides include those described in U.S. Pat. Publ. Nos. 2020/0181370 and 2020/0190270, the disclosures of which are incorporated herein by reference. For example, the polysaccharides can be selected from: poly alpha-1,3-glucan; poly alpha-1,3-1,6-glucan; a water insoluble alpha-(1,3-glucan) polymer having 90% or greater α-1,3-glycosidic linkages, less than 1% by weight of alpha-1,3,6-glycosidic branch points, and a number average degree of polymerization in the range of from 55 to 10,000; dextran; a composition comprising a poly alpha-1,3-glucan ester compound; and water-insoluble cellulose having a weight-average degree of polymerization (DPw) of about 10 to about 1000 and a cellulose II crystal structure.

The carbon black can be untreated carbon black or treated carbon black or a mixture thereof. The filler can be or include wet carbon black in the form of pellets, fluffy powder, granules, and/or agglomerates. Wet carbon black can be formed into pellets, granules, or agglomerates in, e.g., a pelletizer, a fluidized bed or other equipment to make the wet filler.

The wet carbon black can be one or more of the following:
never-dried carbon black; and/or
never-dried carbon black pellets; and/or
dried carbon black pellets that have been rewetted, such as with water in a pelletizer;
and/or
dried carbon black pellets that have been ground and then rewetted with water in a pelletizer; and/or
dried carbon black pellets combined with water; and/or
fluffy powder, granules, or agglomerates combined with water.

In typical carbon black manufacturing, carbon black is initially prepared as dry, fine particulate (fluffy) material. The fluffy carbon black can be densified by a conventional pelletizing process, e.g., by combining the carbon black with a liquid such as adding water and feeding the mixture to a pin pelletizer. Pin pelletizers are well known in the art and include the pin pelletizer described in U.S. Pat. No. 3,528,785. The resulting wet pellets are then heated under controlled temperature and time parameters to remove liquid from the pellets before further handling and shipping. In an alternative process, carbon black pellets can be manufactured by a process that omits a drying step. In such a process, pelletized carbon black contains process water of at least 20% by weight based on a total weight of wet carbon black, e.g., at least 30% by weight, or at least 40% by weight.

Alternatively, carbon black pellets that have been dried (such as commercially available carbon black pellets) can be rewetted in a pelletizer. The pellets can be granulated, ground, classified, and/or milled, e.g., in a jet mill. The resulting carbon black is in fluffy form and can be repelletized in a pelletizer or otherwise compressed or agglomerated in the presence of water to wet the carbon black. Alternatively, the fluffy carbon black can be compressed into other forms, e.g., in a brick form, with equipment known in the art. As another option, carbon black, such as the carbon black pellets or the fluffy carbon black can be wetted, e.g., by using a fluidized bed, sprayer, mixer, or rotating drum, and the like. Where the liquid is water, never-dried carbon black or carbon black that has been rewetted can achieve a water content ranging from 20% to 80%, from 30% to 70% by weight or other ranges, e.g., from 55% to 60% by weight, with respect to the total weight of the wet carbon black.

The carbon black used in any of the methods disclosed herein, whether it be the first and/or second filler, can be any grade of reinforcing carbon blacks and semi-reinforcing carbon blacks or other carbon blacks having statistical thickness surface area (STSA) such as ranging from 20 m²/g to 250 m²/g or higher. STSA (statistical thickness surface area) is determined based on ASTM Test Procedure D-5816 (measured by nitrogen adsorption). Examples of ASTM grade reinforcing grades are N110, N121, N134, N220, N231, N234, N299, N326, N330, N339, N347, N351, N358, and N375 carbon blacks. Examples of ASTM grade semi-reinforcing grades are N539, N550, N650, N660, N683, N762, N765, N774, N787, N990 carbon blacks and/or N990 grade thermal blacks.

As stated, the carbon black can be a rubber black, and especially a reinforcing grade of carbon black or a semi-reinforcing grade of carbon black. Carbon blacks sold under the Regal®, Black Pearls®, Spheron®, Sterling®, Propel®, Endure®, and Vulcan® trademarks available from Cabot Corporation, the Raven®, Statex®, Furnex®, and Neotex® trademarks and the CD and HV lines available from Birla Carbon (formerly available from Columbian Chemicals), and the Corax®, Durax®, Ecorax®, and Purex® trademarks and the CK line available from Orion Engineered Carbons (formerly Evonik and Degussa Industries), and other fillers suitable for use in rubber or tire applications, may also be exploited for use with various implementations. Suitable chemically functionalized carbon blacks include those disclosed in WO 96/18688 and U52013/0165560, the disclosures of which are hereby incorporated by reference. Mixtures of any of these carbon blacks may be employed.

The carbon black can be an oxidized carbon black, such as a carbon black that has been surface treated using an oxidizing agent. In addition, carbon blacks prepared using other surface modification methods to introduce ionic or ionizable groups onto a pigment surface, such as chlorination and sulfonation, may also be used. Processes that can be employed to generate oxidized carbon blacks are known in the art and several types of oxidized carbon black are commercially available.

The carbon black can be a furnace black, a gas black, a thermal black, an acetylene black, or a lamp black, a plasma black, a recovered carbon black (e.g., as defined in ASTM D8178-19), or a carbon product containing silicon-containing species, and/or metal containing species and the like. The carbon black can be a multi-phase aggregate comprising at least one carbon phase and at least one metal-containing species phase or silicon-containing species phase, i.e., silicon-treated carbon black. In silicon-treated carbon black, a silicon containing species, such as an oxide or carbide of silicon, is distributed through at least a portion of the carbon black aggregate as an intrinsic part of the carbon black. Silicon-treated carbon blacks are not carbon black aggregates which have been coated or otherwise modified, but actually represent dual-phase aggregate particles. One phase is carbon, which will still be present as graphitic crystallite and/or amorphous carbon, while the second phase is silica, and possibly other silicon-containing species). Thus, the silicon-containing species phase of the silicon treated carbon black is an intrinsic part of the aggregate, distributed throughout at least a portion of the aggregate. Ecoblack™ silicon-treated carbon blacks are available from Cabot Corporation. The manufacture and properties of these silicon-treated carbon blacks are described in U.S. Pat. No. 6,028,137, the disclosure of which is incorporated herein by reference.

As another option, the filler, whether it be the first and/or second filler, e.g., carbon black, can be chemically treated. For example, the carbon black can have attached at least one organic group. Attachment can occur via a diazonium reaction where the at least one organic group has a diazonium salt substituent as detailed, for instance, in U.S. Pat. Nos. 5,554,739; 5,630,868; 5,672,198; 5,707,432; 5,851,280; 5,885,335; 5,895,522; 5,900,029; 5,922,118, the disclosure of which are incorporated herein by reference.

With regard to the filler, whether it be the first and/or second filler, as an option, being at least silica, one or more types of silica, or any combination of silica(s), can be used in any embodiment disclosed herein. The silica can include or be precipitated silica, fumed silica, silica gel, and/or colloidal silica. The silica can be or include untreated silica and/or chemically-treated silica. The silica can be suitable for reinforcing elastomer composites and can be characterized by a Brunaur Emmett Teller surface area (BET, as determined by multipoint BET nitrogen adsorption, ASTM D1993) of about 20 m²/g to about 450 m²/g. Highly dispersible precipitated silica (“HDS”) is understood to mean any silica having a substantial ability to dis-agglomerate and disperse in an elastomeric matrix. Such dispersion determinations may be observed in known manner by electron or optical microscopy on thin sections of elastomer composite. Examples of commercial grades of HDS include, Perkasil® GT 3000GRAN silica from WR Grace & Co, Ultrasil® 7000 silica from Evonik Industries, Zeosil® 1165 MP, 1115 MP, Premium, and 1200 MP silica from Solvay S.A., Hi-Sil® EZ 160G silica from PPG Industries, Inc., and Zeopol® 8741 or 8745 silica from Evonik Industries. Conventional non-HDS precipitated silica may be used as well. Examples of commercial grades of conventional precipitated silica include, Perkasil® KS 408 silica from WR Grace & Co, Zeosil® 175GR silica from Solvay S.A., Ultrasil® VN3 silica from Evonik Industries, and Hi-Sil® 243 silica from PPG Industries, Inc. Precipitated silica with surface attached silane coupling agents may also be used. Examples of commercial grades of chemically-treated precipitated silica include Agilon® 400, 454, or 458 silica from PPG Industries, Inc. and Coupsil silicas from Evonik Industries, for example Coupsil® 6109 silica. An intermediate form of silica obtained from a precipitation process in a cake or paste form, without drying (a never-dried silica) may be added directly to a mixer as the wet filler, thus eliminating complex drying and other downstream processing steps used in conventional manufacture of precipitated silicas.

In any embodiment and in any step, a coupling agent can be introduced in any of the steps (or in multiple steps or locations) as long as the coupling agent has an opportunity to become dispersed in the composite (e.g., the method further comprises charging the mixer with a coupling agent). The coupling agent can be or include one or more silane coupling agents, one or more zirconate coupling agents, one or more titanate coupling agents, one or more nitro coupling agents, or any combination thereof. The coupling agent can be or include bis(3-triethoxysilylpropyl)tetrasulfane (e.g., Si 69 from Evonik Industries, Struktol SCA98 from Struktol Company), bis(3-triethoxysilylpropyl)disulfane (e.g., Si 75 and Si 266 from Evonik Industries, Struktol SCA985 from Struktol Company), 3-thiocyanatopropyl-triethoxy silane (e.g., Si 264 from Evonik Industries), gamma-mercaptopropyl-trimethoxy silane (e.g., VP Si 163 from Evonik Industries, Struktol SCA989 from Struktol Company), gamma-mercaptopropyl-triethoxy silane (e.g., VP Si 263 from Evonik Industries), zirconium dineoalkanolatodi(3-mercapto) propionato-O, N,N′-bis(2-methyl-2-nitropropyl)-1,6-diaminohexane, S-(3-(triethoxysilyl)propyl) octanethioate (e.g., NXT coupling agent from Momentive, Friendly, WV), and/or coupling agents that are chemically similar or that have the one or more of the same chemical groups. Additional specific examples of coupling agents, by commercial names, include, but are not limited to, VP Si 363 from Evonik Industries, and NXT Z and NXT Z-50 silanes from Momentive. Other compounds that can function as coupling agents include those compounds having a nitroxide radical, e.g., TEMPO (2,2,6,6-tetramethyl-1-piperidinyloxy radical), as disclosed in U.S. Pat. Nos. 6,084,015, 6,194,509, 8,584,725, and U.S. Publ. No. 2009/0292044, the disclosures of which are incorporated by reference herein, or nitrile oxide, nitrile imine and nitrone 1,3-dipolar compounds, as disclosed in U.S. Pat. Nos. 10,239,971, 10,202,471, 10,787,471, and U.S. Publ. No. 2020/0362139, the disclosures of which are incorporated by reference herein. The coupling agents described herein could be used to provide hydrophobic surface modification of silica (precoupled or pretreated silica) before using it in any of the processes disclosed herein. It is to be appreciated that any combination of elastomers, additives, and additional composite may be added to the elastomer composite, for instance in a compounder.

As another option, the mixing (e.g., where the filler comprises silica and/or silicon-treated carbon black) can be performed without coupling agents.

Other fillers are disclosed in U.S. Patent Application Publ. No. 2018/0282523 and European Patent No. 2423253B1, the disclosures of which are incorporated herein by reference.

Particular types of internal mixers are a Banbury mixer or a Brabender mixer, either of which can be used for the methods of forming a composite described herein. The internal mixer can be a tangential internal mixer. The internal mixer can be an intermeshing internal mixer. Other mixers include a kneading type internal mixer. Commercially available internal mixers from Farrel-Pomini, Harburg Freudenberger Maschinenbau GmbH (HF), Kobelco, or Pelmar Eng'r Ltd can be used. Examples of mixers and designs that can be utilized are described in European Patent 2423253B1 and U.S. Pat. No. 7,556,419, the disclosures of which are incorporated herein by reference. As another option, the mixer can be a continuous mixer. For example, the liquid masterbatch and wet filler may be mechanically worked by using one or more of a continuous internal mixer, a twin screw extruder, a single screw extruder, or a roll mill, such as those described in U.S. Pat. No. 9,855,686 B2, the disclosure of which is incorporated herein by reference. Suitable kneading and masticating devices are well known and commercially available, including for example, a Unimix Continuous Mixer and MVX (Mixing, Venting, eXtruding) Machine from Farrel Pomini Corporation of Ansonia, Conn., an FCM™ Farrel Continuous Mixer, a long continuous mixer from Pomini, Inc., a Pomini Continuous Mixer, twin rotor corotating intermeshing extruders, twin rotor counterrotating non-intermeshing extruders, Banbury mixers, Brabender mixers, intermeshing-type internal mixers, kneading-type internal mixers, continuous compounding extruders, the biaxial milling extruder produced by Kobe Steel, Ltd., and a Kobe Continuous Mixer. Alternative masticating apparatus suitable for use with various embodiments of the invention will be familiar to those of skill in the art.

The composite that is discharged can be subjected to one or more post-processing steps. Post-processing can be performed after any mixing step. For a multi-stage mix, post-processing can be performed after the first stage and/or after the second stage and so on. The composite can be post-processed to provide a composite that is dried, homogenized, extruded, calendared, milled, etc. One or more post-processing steps can shape or form or can allow for improved handling but preferably does not substantially disperse the filler.

In any method of producing a composite disclosed herein, the method can further include one or more of the following steps, after formation of the composite:
one or more holding steps;
one or more drying steps can be used to further dry the composite to obtain a dried composite;
one or more extruding steps;
one or more calendaring steps;
one or more milling steps to obtain a milled composite;
one or more granulating steps;
one or more cutting steps;
one or more baling steps to obtain a bailed product or mixture;
the baled mixture or product can be broken apart to form a granulated mixture;
and/or
one or more mixing or compounding steps; and/or
one or more sheeting steps.

As a further example, the following sequence of steps can occur and each step can be repeated any number of times (with the same or different settings), after formation of the composite:
one or more holding steps to develop further elasticity
one or more cooling steps
drying the composite further to obtain a further dried composite;
mixing or compounding the composite to obtain a compounded mixture;
milling the compounded mixture to obtain a milled mixture (e.g., roll milling);
granulating the milled mixture;
optionally baling the mixture after the granulating to obtain a baled mixture;
optionally breaking apart the baled mixture and mixing.

In addition, or alternatively, the composite can be compounded with one or more antidegradants, rubber chemicals, and/or curing agents, and vulcanized to form a vulcanizate. Such vulcanized compounds can have one or more improved properties, such as one or more improved rubber properties, such as, but not limited to, an improved hysteresis, wear resistance and/or rolling resistance, e.g., in tires, or improved mechanical and/or tensile strength, or an improved tan delta and/or an improved tensile stress ratio, and the like.

Rubber chemicals, as defined herein, include one or more of: processing aids (to provide ease in rubber mixing and processing, e.g. various oils and plasticizers, wax), activators (to activate the vulcanization process, e.g. zinc oxide and fatty acids), accelerators (to accelerate the vulcanization process, e.g. sulphenamides and thiazoles), vulcanizing agents (or curatives, to crosslink rubbers, e.g. sulfur, peroxides), and other rubber additives, such as, but not limit to, retarders, co-agents, peptizers, adhesion promoters (e.g., use of cobalt salts to promote adhesion of steel cord to rubber-based elastomers (e.g., as described in U.S. Pat. No. 5,221,559 and U.S. Pat. Publ. No. 2020/0361242, the disclosures of which are incorporated by reference herein), resins (e.g., tackifiers, traction resins), flame retardants, colorants, blowing agents, and additives to reduce heat build-up (HBU), and linking agents such as those described in U.S. Prov. Appl. No. 63/123,386, the disclosure of which is incorporated by reference herein. As an option, the rubber chemicals can comprise processing aids and activators. As another option, the one or more other rubber chemicals are selected from zinc oxide, fatty acids, zinc salts of fatty acids, wax, accelerators, resins, and processing oil. Exemplary resins include those selected from one or more of C5 resins, C5-C9 resins, C9 resins, rosin resins, terpene resins, aromatic-modified terpene resins, dicyclopentadiene resins, alkylphenol resins, and resins disclosed in U.S. Pat. Nos. 10,738,178, 10,745,545, and U.S. Pat. Publ. No. 2015/0283854, the disclosures of which are incorporated by reference herein.

As an example, in a compounding step, the ingredients of the curative package, with the exception of the sulfur or other cross-linking agent and accelerator, are combined with the neat composite in a mixing apparatus (the non-curatives, e.g., rubber chemicals and/or antidegradants, are often pre-mixed and collectively termed “smalls”). The most common mixing apparatus is the internal mixer, e.g., the Banbury or Brabender mixer, but other mixers, such as continuous mixers (e.g., extruders), may also be employed. Thereafter, in a latter or second compounding step, the cross-linking agent, e.g., sulfur, and accelerator (if necessary) (collectively termed curatives) are added. The compounding step is frequently performed in the same type of apparatus as the mixing step but may be performed on a different type of mixer or extruder or on a roll mill. One of skill in the art will recognize that, once the curatives have been added, vulcanization will commence once the proper activation conditions for the cross-linking agent are achieved. Thus, where sulfur is used, the temperature during mixing is preferably maintained substantially below the cure temperature.

Also disclosed herein are methods of making a vulcanizate. The method can include the steps of at least curing a composite in the presence of at least one curing agent. Curing can be accomplished by applying heat, pressure, or both, as known in the art.

Also disclosed herein are articles made from or containing the composite or vulcanizates disclosed herein.

The composite may be used to produce an elastomer or rubber containing product. As an option, the elastomer composite may be used in or produced for use, e.g., to form a vulcanizate to be incorporated in various parts of a tire, for example, tire treads (such as on road or off-road tire treads), including cap and base, undertread, innerliners, tire sidewalls, tire carcasses, tire sidewall inserts, wire-skim for tires, and cushion gum for retread tires, in pneumatic tires as well as non-pneumatic or solid tires. Alternatively or in addition, elastomer composite (and subsequently vulcanizate) may be used for hoses, seals, gaskets, weather stripping, windshield wipers, automotive components, liners, pads, housings, wheel and track elements, tire sidewall inserts, wire-skim for tires, and cushion gum for retread tires, in pneumatic tires as well as non-pneumatic or solid tires. Alternatively or in addition, elastomer composite (and subsequently vulcanizate) may be used for hoses, seals, gaskets, anti-vibration articles, tracks, track pads for track-propelled equipment such as bulldozers, etc., engine mounts, earthquake stabilizers, mining equipment such as screens, mining equipment linings, conveyor belts, chute liners, slurry pump liners, mud pump components such as impellers, valve seats, valve bodies, piston hubs, piston rods, plungers, impellers for various applications such as mixing slurries and slurry pump impellers, grinding mill liners, cyclones and hydrocyclones, expansion joints, marine equipment such as linings for pumps (e.g., dredge pumps and outboard motor pumps), hoses (e.g., dredging hoses and outboard motor hoses), and other marine equipment, shaft seals for marine, oil, aerospace, and other applications, propeller shafts, linings for piping to convey, e.g., oil sands and/or tar sands, and other applications where abrasion resistance and/or enhanced dynamic properties are desired. Further the elastomer composite, via the vulcanized elastomer composite, may be used in rollers, cams, shafts, pipes, bushings for vehicles, or other applications where abrasion resistance and/or enhanced dynamic properties are desired.

Accordingly, articles include vehicle tire treads including cap and base, sidewalls, undertreads, innerliners, wire skim components, tire carcasses, engine mounts, bushings, conveyor belt, anti-vibration devices, weather stripping, windshield wipers, automotive components, seals, gaskets, hoses, liners, pads, housings, and wheel or track elements. For example, the article can be a multi-component tread, as disclosed in U.S. Pat. Nos. 9,713,541, 9,713,542, 9,718,313, and 10,308,073, the disclosures of which are incorporated herein by reference.

### EXAMPLES

### Example A: Preparation of Liquid Masterbatch

This Example describes the preparation of a liquid masterbatch from carbon black slurry and latex.

Carbon Black Slurry Preparation. Dry carbon black (N134) (Cabot Corporation, Boston, MA) was mixed with water and ground to form a slurry having a concentration of about 13.5%. The slurry was fed to a mixing zone of a coagulum reactor as shown in FIGS. 2-4 and 7 of U.S. Pat. No. 6,929,783 by a homogenizer (APV Homogenizer Division, APV Gaulin, Inc., Wilmington, MA) fitted with a flat shaped seat homogenizing valve at an operating pressure of around 3000 psig such that the slurry was introduced into the mixing zone of a coagulum reactor as a jet of finely dispersed carbon black slurry. The carbon black slurry flow rate was adjusted to about 1200-2500 kg/hr to modify final carbon black loading (phr) levels and achieve the desired production rate. The actual carbon black loading levels were determined by nitrogen pyrolysis and thermogravimetric analysis (TGA). Specific carbon black grades and loadings are given in the Tables below.

Natural Rubber Latex Delivery. Field latex having a dry rubber content of about 27-31% (diluted and desludged field latex) was pumped to a mixing portion of a coagulum reactor configured as shown in FIGS. 2-4 and 7 of U.S. Pat. No. 6,929,783. The latex flow rate was adjusted between about 1000-2500 kg/h in order to modify final carbon black loading levels.

Liquid Masterbatch Production. The carbon black slurry and latex were mixed by entraining the latex flow into the carbon black slurry flow in the mixing zone of the coagulum reactor. During the entrainment process, the carbon black was intimately mixed into the latex and the mixture coagulated.

The masterbatch crumb was discharged from the coagulum reactor at a rate between 500 and 1000 kg/hr (dry weight) and dewatered to about 10-20% moisture with a dewatering extruder (The French Oil Machinery Company, Piqua, OH) as illustrated in FIGS. 1, 8 and 9 and described in the text of U.S. Pat. No. 6,929,783.

The dewatered coagulum was dropped into a continuous compounder (Farrel Unimix Continuous Mixer (FCM), equipped with two #15 rotors; operated at 190-320 rpm, Farrel Corporation, Ansonia, CT) where it was masticated and mixed with 1-2 phr of antioxidant (6PPD) as described in U.S. Pat. No. 8,586,651. The moisture content of the masticated masterbatch exiting the FCM was around 1-2% and the temperature was between 140 and 180° C. The product was further masticated, cooled and dried on an open mill. The product was further cooled in a cooling conveyor and cut into small strips, which were compressed together, to form a “loose” product bale of liquid masterbatch. The resulting liquid masterbatch was used in the rubber compound formulations set forth in the Tables below.

### Example B: Preparation of Composites from Liquid Masterbatch, Vulcanizates, and Comparatives

For the composites prepared according to the claimed invention, i.e., (samples with wet carbon black, Ex. 1, 3, 5, 7, and 8; and samples with wet silica, Ex. 9, 10 and 11), wet carbon black and wet silica were obtained by rewetting the dry material with water in a pin pelletizer. The water content is disclosed in Tables 4-7 below.

Mixing and compounding were performed with a BR-1600 Banbury® laboratory mixer (“BR1600” mixer; Farrel Corporation, Ansonia, CT). The BR1600 mixer was operated with two 2-wing, tangential rotors (2WL), providing a capacity of 1.6 L, and all mixing and compounding were performed at a mixer speed of 70 rpm ram pressure of 2.8 bar unless otherwise stated. Times given in Tables 2, 3 and Table 4 are the times for each step in the mixing process.

Natural rubber used was standard grade SMR20 (Hokson Rubber, Malaysia). Technical descriptions of this natural rubber are widely available, such as in Rubber World Magazine's Blue Book published by Lippincott and Peto, Inc. (Akron, Ohio, USA). Butadiene rubber (BR) used was Buna CB 22 from Arlanxeo, Canada. Styrene butadiene rubber (SBR) used was Kralex SBR 1500 from Synthos Rubbers, Czech Republic.

Vulcanizates. The bales of liquid masterbatch were compounded according to the formulations in Table 1 and the processes outlined in Table 2 (both wet filler and dry filler comparative). The TCU temperature of Samples 1, 5, 7 and 9 was 90° C. whereas the TCU temperature of the remaining samples was 60° C. The amounts of masterbatch and unfilled rubber were selected such that the final rubber compound comprised 50 phr filler, unless noted otherwise.

TABLE 1
Rubber Compound Formulation

| Ingredient | Phr |
|---|---|
| Liquid Masterbatch | Variable |
| Additional Filler^{a} | Variable |
| Second Elastomer^{b} | Variable |
| Second Masterbatch^{c} | Variable |
| PEG^{c} | 2.4 |
| ZnO | 3.0 |
| Stearic acid | 2.5 |
| 6PPD^{d} (antioxidant) | 1.5 |
| SantoCure CBS^{e} | 1.2 |
| Sulfur | 1.2 |

^{a}Wet N134 carbon black (samples 1, 3, 5 and 7) or wet N234 carbon black (sample 8) obtained from Cabot Corporation, or wetted Zeosil ® Z1165 MP silica (samples 9, 10 and 11) obtained from Solvay USA Inc., Cranbury, NJ.
^{b}Compositions and mixing conditions for the second masterbatches are given in Table 4.
^{c}Poly(ethylene glycol); PEG 3500 obtained from Akrochem was added to formulations containing silica as the additional filler.
^{d}N-(1,3-dimethylbutyl)-N′-phenyl-p-phenylenediamine
^{e}N-cyclohexyl-2-benzothiazole sulfonamide

TABLE 2
Processes for Mixing Liquid Masterbatch and Wet Filler

| | Samples | | Comparative samples | | Samples 3 | | Comparative | |
|---|---|---|---|---|---|---|---|---|
| Method | 1, 5, 7 and 9 | | C1, C5, C7 and C9 | | and 8 | | samples C3 and C8 | |
| TCU temperature (° C.) | 90 | | 60 | | 60 | | 60 | |
| Liquid masterbatch added | 0 | s | 0 | s | 0 | s | 0 | s |
| Time Filler and additional | 30 | s | 30 | s | 30 | s | 30 | s |
| elastomer or additional | | | | | | | | |
| masterbatch added | | | | | | | | |
| Time smalls added | 125° | C. | 60 | s | 60 | s | 60 | s |
| Time Sweep | 30 | s | 30 | s | 30 | s | 30 | s |
| Dump | 140° | C. | 30 | s | 30 | s | 30 | s |

After dumping, the composites were sheeted on a 2-roll mill operated at 50′C and about 37 rpm, followed by three or five pass-throughs with a nip gap about 5 mm, with a rest time before next stage of mixing of at least 3 hours. Curatives were added in a final (productive) mixing stage as described in Table 3. All compounds were cured at 150° C. for a time determined by (1.1×t90).

TABLE 3
Productive Mixing Stage

| | Time | Operation |
|---|---|---|
| Stage 2 | | Farrel BR Banbury mixer (1600 cc), 65% fill factor, |
| | | 60 rpm, 50° C. |
| | 0 | Add stage 1 compound, sulfur and accelerator |
| | 30 s | Sweep |
| | 30 s | Dump at <120° C. |
| | | Roll mill for one minute with adequate band. |
| | | Remove and perform 6 end rolls. Sheet off to |
| | | required thickness. |

Table 4 provides the specific protocol for the exemplary and comparative second masterbatch samples MB 3, MB 8, MB C3, and MB C8.

TABLE 4

| | Masterbatch | | Masterbatch | | Masterbatch | | Masterbatch | |
|---|---|---|---|---|---|---|---|---|
| | for sample 3 | | for sample 8 | | for sample C3 | | for sample C8 | |
| | (MB 3) | | (MB 8) | | (MB C3) | | (MB C8) | |
| Rubber | SMR 20 | | SBR 1500 | | SMR 20 | | SBR 1500 | |
| Filler | N134 | | N134 | | N134 | | N134 | |
| Filler phr | 50 | | 50 | | 50 | | 50 | |
| Water content of filler (%) | 61 | | 61 | | <1 | | <1 | |
| RPM | 105 | | 105 | | 80 | | 80 | |
| Starting temperature (° C.) | 90 | | 90 | | 60 | | 60 | |
| Add rubber | 0 | s | 0 | s | 0 | s | 0 | s |
| ¾ filler | 30 | s | 30 | s | 30 | s | 30 | s |
| remaining filler | 120 | s | 120 | s | 30 | s | 30 | s |
| Dump | 160° | C. | 160° | C. | 150° | C. | 150° | C. |

Tables, 6 and 7 list carbon black or silica filler type, filler loading, mixing protocol, operating conditions, and resulting data for each sample. Mooney viscosity was measured according to ASTM D1646 at 100° C. Tensile stress at 100% elongation (M100) and tensile stress at 300% elongation (M300) were evaluated by ASTM D412 (Test Method A, Die C) at 23° C., 50% relative humidity and at crosshead speed of 500 mm/min. Extensometers were used to measure tensile strain. The ratio of M300/M100 is referred to as the modulus ratio. Max tan δ was measured with an ARES G2 rheometer (Manufacturer: TA Instruments) in torsional mode. The vulcanizate specimen diameter size was 8 mm diameter and about 2 mm in thickness. The rheometer was operated at a constant temperature of 60′C and at constant frequency of 10 Hz. Strain sweeps were run from 0.1-68% strain amplitude. Measurements were taken at ten points per decade and the maximum measured tan δ was reported. Macrodispersion was measured according to the protocol of ASTM D7723-11. Three images were taken for each sample that was tested, and the average result was taken. The minimum cut-off diameter was 5 μm. The value defined as “white area” in the ASTM standard method is reported here as undispersed area.

TABLE 5
Wet Carbon Black Filler and Dry Carbon Black Filler Comparatives

| Sample No. | 1 | C1 | 3 | C3 | 5 | C5 |
|---|---|---|---|---|---|---|
| Elastomer from liquid | 100 | 100 | 100 | 100 | 100 | 100 |
| masterbatch (phr) | | | | | | |
| Filler type in liquid | N134 | N134 | N134 | N134 | N134 | N134 |
| masterbatch | | | | | | |
| Filler from liquid | 50 | 50 | 50 | 50 | 50 | 50 |
| masterbatch (phr) | | | | | | |
| Additional filler type | N134 | N134 | | | N134 | N134 |
| Additional filler amount | 50 | 50 | | | 10 | 10 |
| (phr) | | | | | | |
| Water content of | 61 | <1 | | | 61 | <1 |
| additional filler (%) | | | | | | |
| Additional elastomer type | NR | NR | | | | |
| Additional elastomer | 100 | 100 | | | | |
| amount (phr) | | | | | | |
| Second masterbatch | | | MB 3 | MB C3 | | |
| Second masterbatch | | | 150 | 150 | | |
| amount (phr) | | | | | | |
| Final composite phr | 50 | 50 | 50 | 50 | 60 | 60 |
| Main stage mix time (s) | 514 | 150 | 150 | 150 | 300 | 150 |
| ML(1 + 4) 100° C. | 73 | 73 | 74 | 67 | 88 | 92 |
| Tensile strength (MPa) | 34.8 | 33.9 | 34.5 | 34.3 | 33.2 | 32.4 |
| M100 (MPa) | 2.95 | 2.81 | 2.68 | 2.77 | 4.19 | 4.03 |
| M300 (MPa) | 17.2 | 16.0 | 16.5 | 16.3 | 21.9 | 21.4 |
| M300/M100 | 5.85 | 5.68 | 6.15 | 5.87 | 5.22 | 5.30 |
| Max Tan δ @ 60° C. | 0.180 | 0.199 | 0.191 | 0.188 | 0.257 | 0.245 |
| Undispersed Area (%) | 1.7 | 9.6 | 3.9 | 4.3 | 0.4 | 1.1 |

TABLE 6
Second Elastomer/Masterbatch; Wet Carbon Black
Filler and Dry Carbon Black Filler Comparatives

| Sample No. | 7 | C7 | 8 | C8 |
|---|---|---|---|---|
| Elastomer from liquid | 100 | 100 | 100 | 100 |
| masterbatch (phr) | | | | |
| Filler type in liquid | N134 | N134 | N134 | N134 |
| masterbatch | | | | |
| Filler from liquid | 50 | 50 | 50 | 50 |
| masterbatch (phr) | | | | |
| Additional filler type | N134 | N134 | | |
| Additional filler amount | 10 | 10 | | |
| (phr) | | | | |
| Water content of | 61 | <1 | | |
| additional filler (%) | | | | |
| Additional elastomer type | BR | BR | | |
| Additional elastomer | 20 | 20 | | |
| amount (phr) | | | | |
| Second masterbatch | | | MB 8 | MB C8 |
| Second masterbatch | | | 45 | 45 |
| amount (phr) | | | | |
| Final composite phr | 50 | 50 | 50 | 50 |
| Main stage mix time (s) | 300 | 150 | 150 | 150 |
| ML(1 + 4) 100° C. | 83 | 84 | 71 | 71 |
| Tensile strength (MPa) | 32.7 | 30.9 | 32.2 | 30.9 |
| M100 (MPa) | 3.24 | 3.08 | 2.76 | 2.52 |
| M300 (MPa) | 17.9 | 16.8 | 16.4 | 14.9 |
| M300/M100 | 5.52 | 5.42 | 5.93 | 5.92 |
| Max Tan δ @ 60 C. | 0.192 | 0.190 | 0.214 | 0.227 |
| Undispersed Area (%) | 0.9 | 4.5 | 0.4 | 0.8 |

TABLE 7
Wet Silica Filler and Dry Silica Filler Comparative

| Sample No. | 9 | C9 |
|---|---|---|
| Elastomer from liquid masterbatch (phr) | 100 | 100 |
| Filler type in liquid masterbatch | N234 | N234 |
| Filler from liquid masterbatch (phr) | 50 | 50 |
| Additional filler type | Z1165 | Z1165 |
| Additional filler amount (phr) | 15 | 15 |
| Water content of additional filler (%) | 52 | 2 |
| Additional elastomer type | NR | NR |
| Additional elastomer amount (phr) | 30 | 30 |
| Final composite phr | 50 | 50 |
| ML(1 + 4) 100° C. | 77 | 75 |
| Tensile strength (MPa) | 32.8 | 32.6 |
| M100 (MPa) | 2.18 | 2.00 |
| M300 (MPa) | 13.3 | 12.0 |
| M300/M100 | 6.11 | 6.02 |
| Max Tan δ @ 60 C. | 0.108 | 0.126 |
| Undispersed Area (%) | 1.3 | 2.0 |

As can be seen from Tables 5-7, addition to liquid masterbatch of filler in wet form, and optionally secondary elastomer, according to the process of the invention produced rubber compounds having superior dispersion of filler in the rubber, and generally superior rubber properties, e.g., higher M300, modulus ratio and/or lower tan δ values than observed for comparable rubber compounds prepared by addition to liquid masterbatch of filler in dry form. In the case of liquid masterbatch comprising natural rubber, formulation of rubber compounds with wet filler and liquid masterbatch can be carried out under more intense mixing conditions to achieve dispersion levels associated with better rubber reinforcement properties without degrading the rubber. Rubber compositions of the invention were characterized by enhanced filler dispersion. Intermediate composite properties, such as Mooney viscosity, demonstrate the suitability of the invention for use in conventional rubber compound processing, e.g., in compounding rubber formulations for the manufacture of tires and industrial rubber articles. Further, these results unexpectedly were achieved on conventional rubber mixing equipment utilizing selected sets of process conditions according to the invention.

The use of the terms “a” and “an” and “the” are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A method of preparing a composite, comprising:
(a) charging a mixer having one or more rotors with: (i) at least a liquid masterbatch comprising a first filler dispersed in at least one elastomer, and (ii) a wet filler comprising a second filler and a liquid present in an amount ranging from 15% to 65% by weight based on total weight of wet filler;
(b) in one or more mixing steps, mixing the at least the liquid masterbatch and the wet filler to form a mixture, wherein in at least one of said mixing steps conducting said mixing at mixer temperatures controlled by at least one temperature-control means, and removing at least a portion of the liquid from the mixture by evaporation; and
(c) discharging, from the mixer, the composite comprising the first and second fillers dispersed in the at least one elastomer at a total loading of at least 20 phr, wherein the composite has a liquid content of no more than 10% by weight based on total weight of said composite.

2. The method of claim 1, wherein in step (b) and optionally in step (a), the at least one temperature-control means is set to a TCU temperature of 65° C. or higher.

3. The method of claim 1, wherein in step (b) and optionally in step (a), the at least one temperature-control means is set to a TCU temperature ranging from 65° C. to 100° C.

4. The method of claim 1, wherein one or more rubber chemicals are absent from the composite discharged in step (c).

5. The method of claim 1, wherein the wet filler has a liquid present in an amount of ranging from 30% to 65% by weight.

6. The method of claim 1, wherein the at least one elastomer is selected from natural rubber, functionalized natural rubber, styrene-butadiene rubber, functionalized styrene-butadiene rubber, polybutadiene rubber, functionalized polybutadiene rubber, polyisoprene rubber, ethylene-propylene rubber, isobutylene-based elastomers, polychloroprene rubber, nitrile rubber, hydrogenated nitrile rubber, polysulfide rubber, polyacrylate elastomers, fluoroelastomers, perfluoroelastomers, silicone elastomers, and blends thereof.

7. The method of claim 1, wherein the charging further comprises charging the mixer with at least one additional elastomer.

8. The method of claim 7, wherein the at least one additional elastomer is different from the at least one elastomer of the liquid masterbatch to form a composite comprising an elastomer blend.

9. The method of claim 8, wherein the at least one elastomer of the liquid masterbatch is natural rubber and the at least one additional elastomer is selected from polybutadiene and styrene-butadiene rubber.

10. The method of claim 1, wherein the filler comprises at least one material selected from carbonaceous materials, carbon black, silica, nanocellulose, lignin, clays, nanoclays, metal oxides, metal carbonates, pyrolysis carbon, reclaimed carbon, graphenes, graphene oxides, reduced graphene oxide, carbon nanotubes, combinations thereof, and coated and treated materials thereof.

11. The method of claim 1, wherein the filler comprises at least one material selected from carbon black, silica, and silicon-treated carbon black.

12. The method of claim 1, wherein the filler comprises carbon black.

13. The method of claim 1, wherein the wet filler comprises never-dried carbon black.

14. The method of claim 1, wherein the wet filler comprises dry carbon black that has been rewetted.

15. The method of claim 1, wherein the filler comprises silica.

16. The method of claim 1, wherein the wet filler comprises never-dried silica.

17. The method of claim 1, wherein the wet filler comprises dry silica that has been rewetted.

18. The method of claim 1, further comprising charging the mixer with a coupling agent.

19. A method of preparing a vulcanizate, comprising:
curing the composite prepared by the method of claim 1 in the presence of at least one curing agent to form the vulcanizate.

20. An article comprising the vulcanizate prepared by the method of claim 19.
